(19) United States
(12) Patent Application Publication
(10) Pub. No.: US 2010/0246852 A1
(43) Pub. Date: Sep. 30, 2010

(54) Output-level-controlling converter device

(76) Inventor: Jy-Der David Tai, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,260

(22) Filed: May 5, 2009

(30) Foreign Application Priority Data
Mar. 24, 2009 (TW) 098109511

(51) Int. Cl. H04B 15/00

(52) U.S. Cl. 381/94.5

(57) ABSTRACT

An output-level-controlling converter device, including a ramp generator, used to generate a ramp signal; and an analog-to-PWM converter, said converter is used to perform conversion digitally for a reference signal by making use of said ramp signal, and output a pulse-width-modulation signal; and a pulse width detector, used to detect a duty cycle of said pulse-width-modulation signal, and output a gain control voltage signal based on said duty cycle, and when said duty cycle is close to 0% or 100%, said ramp generator is used to increase a voltage amplitude of said ramp signal based on a voltage value of said gain control voltage signal, hereby increasing or decreasing said duty cycle of said pulse-width-modulation signal for reducing voltage gain of said reference signal.

### BACKGROUND OF THE INVENTION

1. Field of the Invention

The present invention relates to a converter device, and in particular to an output-level-controlling converter device.

2. The Prior Arts

In general, the design and operation principle of an amplifier is that, the amplifier is utilized to receive an input signal, then amplify the signal, and finally output the amplified signal. In this way, the design and operation principle of an ordinary audio frequency power amplifier is to receive an audio frequency signal, amplify the signal, and finally output a signal of large current into a loudspeaker. Due to the fact that the dynamic range of music or audio frequency signal variations is rather large, and its sound intensity will vary significantly along with the time, and since the magnitudes of the audio frequency signals transmitted to an audio frequency power amplifier from various broadcasting devices vary greatly, thus on certain occasions, the audio frequency power amplifier will receive signals of unexpectedly and exceedingly high voltage. And when this audio frequency power amplifier receives an input signal of exceedingly high voltage, the correspondingly high voltage of its output signal will be cut off by the upper and lower limits of power source voltage, thus resulting in high distortion of signals. In this situation, harmonic distortion will be exceedingly large, hereby causing loudspeaker to produce very loud but unpleasant sound, or even burning out the loudspeaker.

In the above-mentioned conditions, in case that an audio frequency power amplifier is used to drive a base or super base loudspeaker, then the output sound of loudspeaker is very much unpleasant. Or, otherwise, in case that an audio frequency power amplifier is used to drive a loudspeaker of small sound volume capacity, such as, a loudspeaker of exceedingly small sound volume capacity in a portable electronic device, then this kind of loudspeaker is liable to be burned out.

In order to avoid the situations mentioned above, a solution is proposed to add an additional automatic gain controller (AGC), that is utilized to regulate the voltage gain of an amplifier. However, this automatic gain controller (AGC) tends to increase/reduce voltage gain of amplifier in its normal operating range all the time. As such, the output voltage of an amplifier is not capable of reproducing and broadcasting the low sound and loud sound of the music according to their original proportion in its entire fidelity, hereby resulting in reduction in the dynamic voltage range of output signal variations. Therefore, presently, the performance of this kind of design is not quite satisfactory.

In view of the problems and shortcomings of the prior art, the present invention provides an output-level-controlling converter device, so as to solve the afore-mentioned problems of the prior art.

### SUMMARY OF THE INVENTION

A major objective of the present invention is to provide an output-level-controlling converter device, wherein, an analog-to-PWM converter is utilized to receive a ramp signal and a reference signal, and perform analog-to-PWM conversion for the reference signal, and output a pulse-width-modulation (PWM) signal, and when duty cycle of this modulation signal is close to 0% or 100%, that is used to increase the amplitude of voltage of a ramp signal, so as to make the current duty cycle greater or less than the original duty cycle. In addition, when voltage of a ramp signal is cut off by a voltage upper limit or a voltage lower limit, this analog-to-PWM converter is used to perform attenuation of the reference signal digitally, hereby reducing voltage gain of the reference signal. The application of this output-level-controlling converter device will enable an ordinary audio frequency power amplifier to reduce the distortion of a saturation output signal or reduce its output power for protecting loudspeaker while proceeding with signal conversions digitally.

In order to achieve the above-mentioned objective, the present invention provides an output-level-controlling converter device, including a ramp generator, used to generate a ramp signal; and an analog-to-PWM converter, with its first and second terminals utilized to receive the ramp signal and a reference signal, and perform analog-to-PWM conversion for the reference signal, hereby outputting a pulse-width-modulation signal. Each of the output terminals of the ramp generator and the analog-to-PWM converter is connected respectively to a pulse width detector, and that is used to detect the duty cycle of a pulse-width-modulation signal, and output a gain control voltage signal based on said duty cycle. Then, when the duty cycle is close to 0% or 100%, the ramp generator is used to increase the voltage amplitude of said ramp signal based on voltage value of the gain control voltage signal, thus making the duty cycle of the pulse-width-modulation signal greater than or less than the original duty cycle, hereby reducing the voltage gain of the reference signal.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed description of the present invention to be made later are described briefly as follows, in which:

FIG. 1 is a schematic diagram of an output-level-controlling converter device according to a first embodiment of the present invention;

FIGS. 2(a) to 2(d) are waveform diagrams showing the waveforms of un-amplified trigonometric wave signal and waveforms of analog signals of various voltage levels in FIG. 2(a), and the waveforms of pulse-width-modulation signals in FIGS. 2(b) to 2(d) as produced by the signals in FIG. 2 (a);

FIGS. 3(a) to 3(c) are waveform diagrams showing the waveforms of un-amplified trigonometric wave signal, amplified trigonometric wave signal and waveforms of analog signals of various voltage levels in FIG. 3a, and the waveforms of pulse-width-modulation signals in FIGS. 3(b) to 3(c) as produced by the signals in FIG. 3 (a);

FIG. 4 is a waveform diagram showing the waveforms of original sine wave signal, un-amplified trigonometric wave signal, amplified trigonometric wave signal, and the filtered sine wave signal as generated by the above-mentioned waves;

FIG. 5 is a schematic diagram of an output-level-controlling converter device according to a second embodiment of the present invention; and

FIG. 6 is a waveform diagram of a controlled reference signal, its corresponding ramp signal, and filtered pulse-width-modulation signal of various voltage levels according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

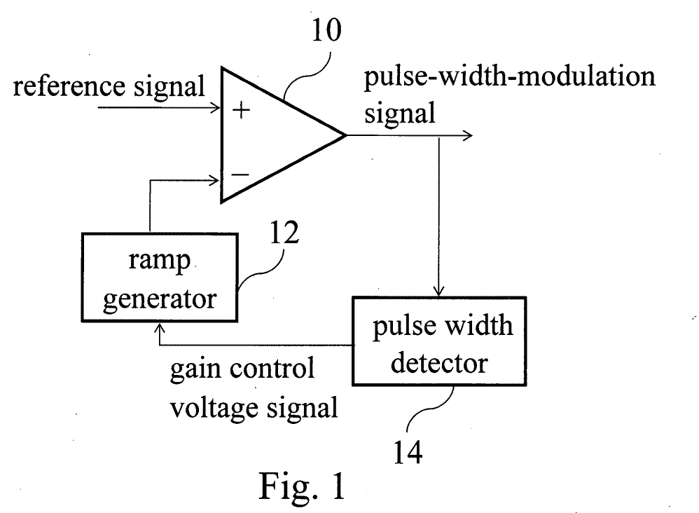

In order to eliminate or at least alleviate the phenomenon that an audio frequency power amplifier tends to produce serious signal distortion when receiving an input signal of exceedingly high voltage, the present invention discloses an output-level-controlling converter device, that can be utilized in performing signal conversion digitally for an ordinary audio frequency power amplifier. Referring to FIG. 1 for a schematic diagram of an output-level-controlling converter device according to a first embodiment of the present invention. As shown in FIG. 1, the output-level-controlling converter device of the present invention includes an analog-to-PWM converter 10, having its negative input terminal connected to a ramp generator 12, and that is used to generate a ramp signal; furthermore, the negative input terminal and positive input terminal of analog-to-PWM converter 10 are utilized to receive this ramp signal and a reference signal respectively, and the ramp signal is used to perform analog-to-PWM conversion for reference signal, then output a pulse-width-modulation signal. In the descriptions mentioned above, the reference signal can be an analog signal or a sine wave signal, moreover, the ramp generator 12 can be a saw-tooth wave signal generator or a trigonometric wave signal generator, and that is utilized to generate a saw-tooth wave signal or a trigonometric wave signal.

In addition, an input terminal of ramp generator 12 and an output terminal of analog-to-PWM converter 10 are connected respectively to a pulse width detector 14, and that is used to detect duty cycle of the pulse-width-modulation signal, and output a gain control voltage signal based on this duty cycle. The gain control voltage signal is received by a ramp generator 12, and when its duty cycle is close to 0% or 100%, the pulse width detector 14 will generate a gain control voltage signal of higher voltage. Then, the ramp generator 12 is used to increase the voltage amplitude of ramp signal based on the voltage value of the gain control voltage signal, thus making the duty cycle of the pulse-width-modulation signal greater than or less than the original duty cycle, hereby reducing the voltage gain of the reference signal.

In case that duty cycle of pulse-width-modulation signal is not close to 0% or 100%, then the gain control voltage signal output by the pulse width detector 14 will keep its original voltage value, and ramp generator 12 will not increase voltage amplitude of ramp signal, while the voltage gain of the reference signal will remain unchanged. In other words, when voltage of reference signal does not exceed a rated value, then its voltage gain will remain a constant value.

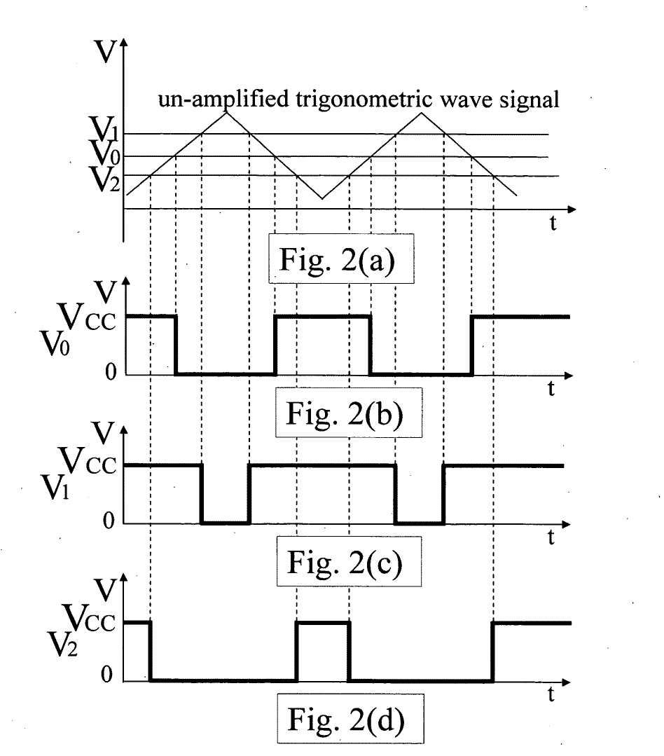

In the following, the waveforms generated by a circuit of the first embodiment of the present invention are described in detail. Referring to FIGS. 2(a) to 2(d) for waveform diagrams showing the waveforms of un-amplified trigonometric wave signals and waveforms of analog signals of various voltage levels in FIG. 2(a), and the waveforms of pulse-width-modulation signals in FIGS. 2(b) to 2(d) as produced by the signals in FIG. 2(a). As shown in FIGS. 2(a) to 2(d), for the reference signal utilized herein, the analog signal of direct current voltage is taken as an example, and for a ramp signal, the trigonometric wave signal is taken as an example. In case that the voltage of analog signal is not close to peak voltage or trough voltage of a trigonometric wave signal, the voltage amplitude of the trigonometric wave signal remains unchanged. For un-amplified trigonometric wave signals and analog signals of voltage level V₀, the analog-to-PWM converter 10 performs analog-to-PWM conversion of the analog signal based on the voltage at the intersection point of an un-amplified trigonometric wave signal and an analog signal, hereby outputting a pulse-width-modulation signal. Since the time interval of positive voltage and time interval of negative voltage are equal for the pulse-width-modulation signal generated at the interaction point of an un-amplified trigonometric wave signal and an analog signal, so that the duty cycle of this pulse-width-modulation signal is 50%, as shown in FIG. 2(b). Moreover, for an un-amplified trigonometric wave signal and an analog signal of voltage level V₁, since voltage level V₁ is greater than V₀, therefore, the time interval of positive voltage is greater than the time interval of negative voltage for the pulse-width-modulation signal generated at the interaction point of an un-amplified trigonometric wave signal and an analog signal, such that the duty cycle of this pulse-width-modulation signal is greater than 50%, as shown in FIG. 2(c). Furthermore, for an un-amplified trigonometric wave signal and an analog signals of voltage level V₂, since voltage level V₂ is less than V₀, the time interval of positive voltage is less than the time interval of negative voltage for the pulse-width-modulation signal generated at the interaction point of an un-amplified trigonometric wave signal and an analog signal, so that the duty cycle of this pulse-width-modulation signal is less than 50%, as shown in FIG. 2(d).

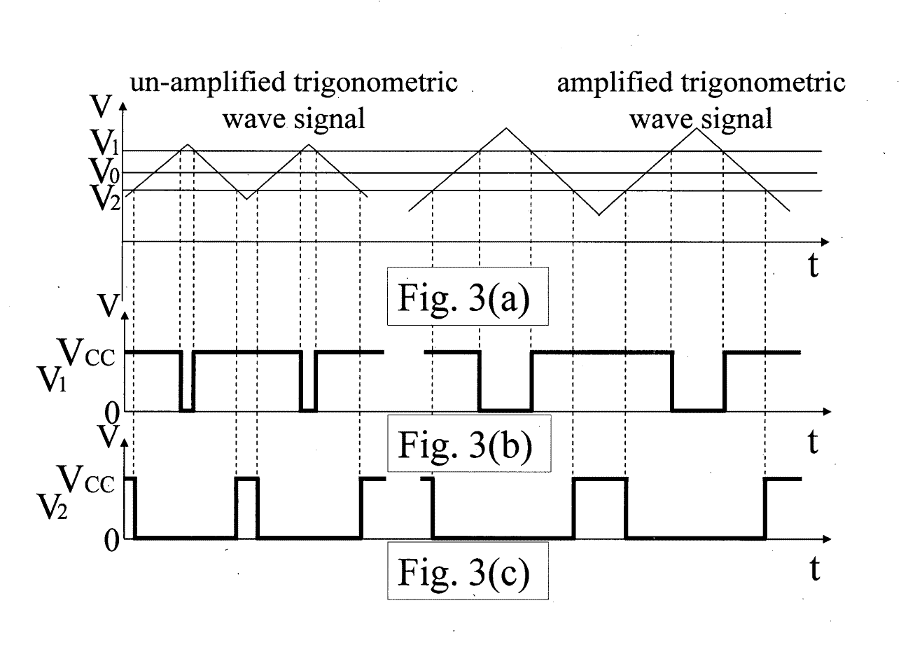

Subsequently, referring simultaneously to FIG. 1 and also FIGS. 3(a) to 3(c) respectively. Wherein, FIG. (1) shows a schematic diagram of an output-level-controlling converter device according to a first embodiment of the present invention; and FIGS. 3(a) to 3(c) show the waveforms of un-amplified trigonometric wave signal, amplified trigonometric wave signal and waveforms of digital signals of various voltage levels in FIG. 3a, and the waveforms of pulse-width-modulation signals in FIGS. 3(b) to 3(c) as produced by the signals in FIG. 3 (a). As shown in FIGS. 3(a) to 3(c), for an un-amplified trigonometric wave signal and an analog signal of voltage level V₁, since the voltage level V₁ is close to peak voltage of un-amplified trigonometric wave signal, thus the duty cycle of a pulse-width-modulation signal output by analog-to-PWM converter 10 is close to 100% such as 99%, and the waveform of the pulse-width-modulation signal is shown on the left side of FIG. 3(b). However, when pulse width detector 14 detects and finds out that the duty cycle of a pulse-width-modulation signal output by analog-to-PWM converter 10 is close to 100%, it will output a gain control voltage signal of higher voltage, namely increasing it voltage value. As such, upon receiving the gain control voltage signal by the ramp generator 12, it will increase the voltage amplitude of an un-amplified trigonometric wave signal, with its waveform as shown on the right side of FIG. 3(a). At this time, the duty cycle of a pulse-width-modulation signal output by analog-to-PWM converter 10 will be less than its original duty cycle with it waveform as shown on the right side of FIG. 3(b). Since the portion of high level output voltage of the pulse-width-modulation signal is reduced, that means the signal intensity is decreased, namely, the gain of analog signal of voltage level V₁ is decreased, hereby preventing the duty cycle of the pulse-width-modulation signal from entering into 100% for becoming saturated and thus resulting in distortion.

In addition, for an un-amplified trigonometric wave signal and an analog signal of voltage level V₂, since the voltage level V₂ is close to trough voltage of an un-amplified trigonometric wave signal, thus the duty cycle of a pulse-width-modulation signal output by analog-to-PWM converter 10 is close to 0% such as 1%, with the waveform of the pulse-width-modulation signal as shown on the left side of FIG. 3(c). However, when pulse width detector 14 detects and finds out that the duty cycle of a pulse-width-modulation signal output by analog-to-PWM converter 10 is close to 0%, it will output a gain control voltage signal of higher voltage, namely increasing it voltage value. As such, upon receiving the gain control voltage signal by the ramp generator 12, it will increase the voltage amplitude of an un-amplified trigonometric wave signal, with its waveform as shown on the right side of FIG. 3(a). At this time, the duty cycle of a pulse-width-modulation signal output by analog-to-PWM converter 10 will be greater than its original duty cycle with its waveform as shown on the right side of FIG. 3(c). Since the portion of low level output voltage of the pulse-width-modulation signal is reduced, that means its signal intensity is increased, namely, the voltage gain of analog signal of voltage level V₂ is increased, hereby preventing the duty cycle of the pulse-width-modulation signal from entering into 0% for becoming saturated and thus resulting in distortion.

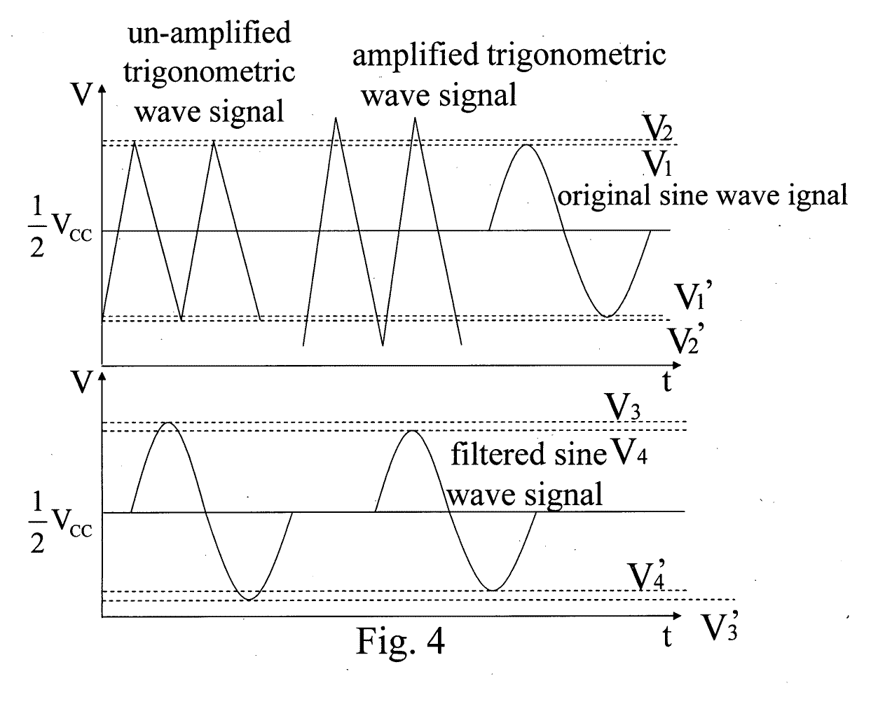

Furthermore, in case that an original sine wave signal is taken as an example for a reference signal, such that in this case, a filter is used to filtered out an original sine wave signal from a pulse-width-modulation signal, then a filtered sine wave signal, an amplified trigonometric wave signal, an un-amplified trigonometric wave signal, and an original sine wave signal are as shown in FIG. 4. As shown in FIG. 4, the peak voltage and trough voltage of the original sine wave signal is V₁ and V₁ respectively, that are very close to the peak voltage V₂ and trough voltage V₂ of the un-amplified trigonometric wave signals. At this time, the duty cycle of an un-amplified trigonometric wave signal at wave peak and wave trough of the original sine wave signal, and the duty cycle of pulse-width-modulation signal generated by original sine wave signal are very close to 100% and 0% respectively, and the peak voltage and trough voltage of a filtered sine wave signal are V₃ and V₃ respectively. However, in case that conversion is performed for an amplified trigonometric wave signal and an original sine wave signal, then the duty cycles of pulse-width-modulation signal generated at wave peak and wave trough of the original sine wave signal will move far away from 100% and 0% respectively, and the peak voltage and trough voltage of filtered sine wave signal are V₄ and V_{4′} respectively. As such, the application of conversion of trigonometric wave signal after it being amplified tends to reduce the voltage gain of a reference signal.

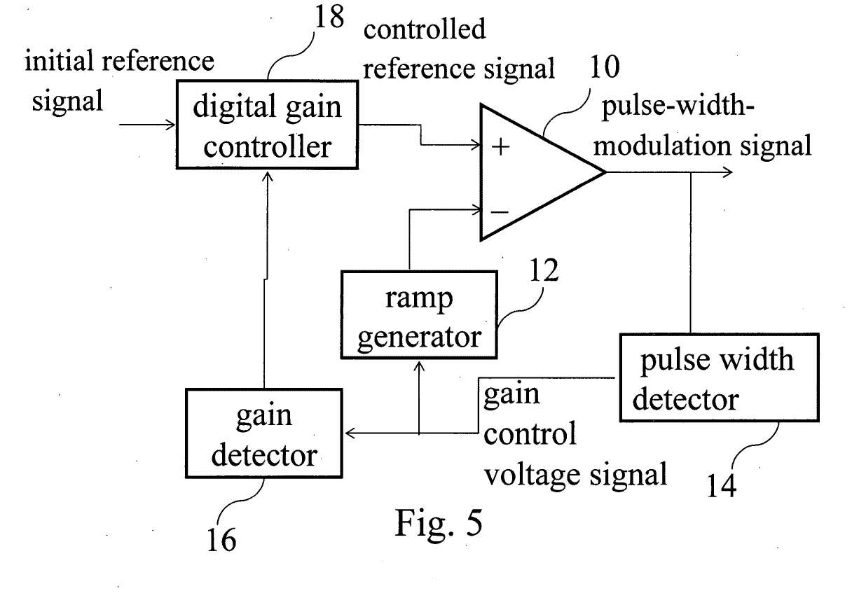

Subsequently, referring to FIG. 5 for a schematic diagram of an output-level-controlling converter device according to a second embodiment of the present invention. The composition of output-level-controlling converter device of the second embodiment is the same as that of the first embodiment, the differences are an additionally added gain detector 16 and a digital gain controller 18. Wherein, the gain detector 16 is connected to a ramp generator 12 and a pulse width detector 14, and digital gain controller 18 is connected to gain detector 16 and a positive input terminal of analog-to-PWM converter 10. The digital gain controller 18 is used to receive an initial reference signal, and output a controlled reference signal into an analog-to-PWM converter 10. The initial reference signal and the controlled reference signal can both be sine wave signal or analog signal. The gain detector 16 may detect the voltage levels of gain control voltage signals periodically. Since, a pulse width detector 14 periodically detects the duty cycle of pulse-width-modulation signal so as to change the voltage level of the gain control voltage signal, such that gain detector 16 may detect indirectly the duty cycle of the pulse-width-modulation signal, and when this duty cycle is equal to 100%, the pulse width detector 14 outputs a gain control voltage signal of higher voltage level. When gain detector 16 detects this gain control voltage signal of higher voltage level, it will send out a control signal to a digital gain controller 18. Then, the digital gain controller 18 will proceed with attenuation of an initial reference signal, and output a controlled reference signal to an analog-to-PWM converter 10, hereby preventing a pulse-width-modulation signal from entering into duty cycle of 100% . In case that the duty cycle of the pulse-width-modulation signal is no longer in a state of 100% duty cycle, then the pulse width detector 14 will output a gain control voltage signal of lower voltage level. Therefore, after certain period of time, in case that gain detector 16 detects this gain control voltage signal of lower voltage level, then it will control the digital gain controller 18 in terminating the attenuation of the controlled reference signal, so that the controlled reference signal will return to its original voltage level, and will be transmitted directly into an analog-to-PWM converter 10.

In contrast, when the duty cycle of pulse-width-modulation signal is equal to 0%, the pulse width detector 14 outputs a gain control voltage signal of higher voltage level, and when the gain detector 16 detects this gain control voltage signal of higher voltage, it will send out a control signal into a digital gain controller 18. Then, the digital gain controller 18 will proceed with attenuation of voltage of an initial reference signal, and output a controlled reference signal to an analog-to-PWM converter 10, hereby preventing a pulse-width-modulation signal from being in 0% duty cycle. In case that the duty cycle of the pulse-width-modulation signal is no longer in a state of 0% duty cycle, then the pulse width detector 14 will output a gain control voltage signal of lower voltage level. Therefore, after certain period of time, in case that gain detector 16 detects this gain control voltage signal of lower voltage level, then the digital gain controller 18 will terminate the attenuation of the controlled reference signal, so that the controlled reference signal will return to its original level of voltage, and will be transmitted directly into the analog-to-PWM converter 10.

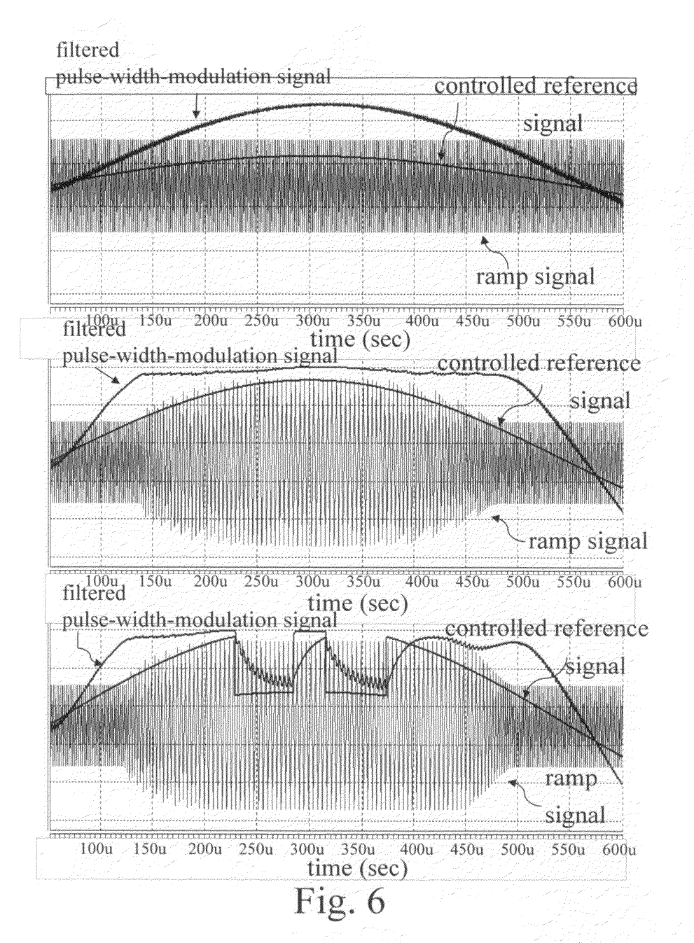

Finally, referring to FIG. 6 for a waveform diagram for a ramp signal, a controlled reference signal, and a filtered pulse-width-modulation signal at various voltage levels obtained through simulation of the operations of a real circuit. As shown in FIG. 6, a filtered pulse-width-modulation signal is a remaining portion of a signal obtained through filtering out reference signal from pulse-width-modulation signal, the waveforms on the upper most portion of drawings represent the waveforms that when voltage amplitude range of a controlled reference signal is in voltage amplitude range of a ramp signal, so that duty cycle of a pulse-width-modulation signal generated through using a controlled reference signal and a ramp signal will not get close to 100%, such that the filtered pulse-width-modulation signal is normal, and its waveform is the same as that of the controlled reference signal without having distortions.

Moreover, as shown in waveforms in the center portion of the drawings, a controlled reference signal is a signal of high voltage level, with its voltage value greater than that of the original ramp signal. In this drawing, the voltage value of the controlled reference signal gets close to the peak voltage value of a slant signal at the time of 150 μs. At this time, the duty cycle of pulse-width-modulation signal generated through using a controlled reference signal and a ramp signal will get close to 100%, so that the voltage amplitude of ramp signal will increase until it will return to normal value along with the decrease of voltage value of the controlled reference signal at around 475 μs. In the interval between around 150 μs and 475 μs, the related duty cycle of pulse-width-modulation signal is close to 100%, so that voltage of the filtered pulse-width-modulation signal will increase slowly from around 150 μs until it reaches saturation at 300 μs. When voltage of controlled reference signal starts to decrease, then the voltage of the filtered pulse-width-modulation signal will depart from saturation and drop down slowly, until voltage of a controlled reference signal is less than that of a ramp signal at around 475 μs. In other words, in the interval mentioned above, the voltage gain of controlled reference signal will decrease in an attempt to keep voltage output level in a non-saturation region, thus it may alleviate the distortion of the saturation signal.

Furthermore, referring to drawing in the lowest portion of FIG. 6, wherein, it shows the waveforms that when the voltage amplitude of a controlled reference signal is greater than a voltage upper limit of a ramp signal having its voltage amplitude amplified, hereby resulting in its duty cycle being equal to 100% for a pulse-width-modulation signal. Therefore, in this manner, gain detector 16 is in control of a digital gain controller 18 in performing attenuation of an initial reference signal and producing a controlled reference signal. As such, as shown in the drawing, attenuation is performed digitally for an initial reference signal in an interval between around 227 μs and around 278 μs, as such, the voltage of controlled reference signal after attenuation will move far away from the peak voltage value of a ramp signal, thus reducing the duty cycle of the pulse-width-modulation signal. At this time, the pulse width detector 14 will instead output a gain control voltage signal of lower voltage level. After a certain period of time, when gain detector 16 detects the existence of this gain control voltage signal of lower voltage level, it will control the gain controller 18 in terminating the attenuation of the controlled reference signal, hereby enabling the controlled reference signal to return to its original voltage level as shown in time point around 280 μs of the horizontal axis. The detections and operations mentioned above will be performed periodically in a time duration of such as time interval between around 315 μs and around 375 μs as shown in the drawing, until the voltage of the controlled reference signal is reduced to lower than the peak voltage value of the ramp signal. In addition, from the behavior of the filtered pulse-width-modulation signal it can be known that, along with the digital attenuation of the controlled reference signal, the voltage value of the filtered pulse-width-modulation signal will also drop down consequently, thus the voltage gain of the controlled reference signal will decrease in producing lower output power. As such, through the application of correlating digital attenuation and gain reduction, the output power can be reduced, hereby protecting the loudspeaker from being damaged.

Summing up the above, the output-level-controlling converter device of the present invention can be utilized in reducing distortion of saturation output signals and output power of an ordinary audio frequency power amplifier, when the ordinary audio frequency power amplifier receives input reference signals of abnormally high voltage while performing signal conversion digitally, thus protecting a loudspeaker from being damaged.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An output-level-controlling converter device, comprising:
a ramp generator, used to generate a ramp signal;
an analog-to-PWM converter, with its first and second input terminals utilized to receive said ramp signal and a reference signal, performing analog-to-PWM conversion for said reference signal by making use of said ramp signal, thus outputting a pulse-width-modulation signal; and
a pulse width detector, connected to said ramp generator and an output terminal of said analog-to-PWM converter, and is used to detect a duty cycle of said pulse-width-modulation signal, and output a gain control voltage signal based on said duty cycle, when said duty cycle is close to 0% or 100%, said ramp generator is used to increase a voltage amplitude of said ramp signal based on a voltage value of said gain control voltage signal received, thus making said duty cycle of said pulse-width-modulation signal greater than or less than an original duty cycle, hereby reducing a voltage gain of said reference signal.

2. The output-level-controlling converter device as claimed in claim 1, wherein said analog-to-PWM converter is utilized to perform analog-to-PWM conversion for said reference signal, as based on said voltage value at an intersection point of said ramp signal and said reference signal.

3. The output-level-controlling converter device as claimed in claim 1, wherein when said duty cycle is close to 0% or 100%, said voltage value of said gain control voltage signal will increase, hereby increasing said voltage amplitude of said ramp signal.

4. The output-level-controlling converter device as claimed in claim 1, further comprising:
a digital gain controller, connected to said second input terminal of said analog-to-PWM converter, and said digital gain controller is used to control said reference signal transmitted to said analog-to-PWM converter; and
a gain detector, connected to said ramp generator, said digital gain controller, and said pulse width detector, and is used to detect voltage of said gain control voltage signal periodically, and when said duty cycle is equal to 0% or 100%, said gain detector is used to control said digital gain controller in first performing attenuation of said reference signal, and then said signal is output into said analog-to-PWM converter, and then when said duty cycle is greater than 0% or lower than 100%, said gain detector is used to control said digital gain controller in terminating attenuation of said reference signal, so that said reference signal is transmitted directly into said analog-to-PWM converter.

5. The output-level-controlling converter device as claimed in claim 1, wherein said reference signal is an analog signal or a sine wave signal.

6. The output-level-controlling converter device as claimed in claim 1, wherein said ramp generator is a saw-tooth wave signal generator or a trigonometric wave signal generator, and said wave signal generated is a saw-tooth wave signal or a trigonometric wave signal respectively.

7. The output-level-controlling converter device as claimed in claim 1, wherein in case that a positive voltage time interval and a negative voltage time interval are equal, then said duty cycle is 50%.
